(19) United States
(12) Patent Application Publication
(10) Pub. No.: US 2005/0019460 A1
(43) Pub. Date: Jan. 27, 2005

(54) Magnesium-enriched compositions

(76) Inventor: Olivier Roujansky, Bordeaux (FR)

Correspondence Address: Roujansky Olivier, 33005 Bordeaux Cedex, 29 Rue Costedoat BP 572, Bordeaux, 33005, FR

(21) Appl. No.: 10/483,554

(22) PCT Filed: May 2, 2002
(86) PCT No.: PCT/FR02/01524

(30) Foreign Application Priority Data
May 11, 2001 (FR) 01/06227

(51) Int. Cl. A23C 3/00

(52) U.S. Cl. 426/330.2

(57) ABSTRACT

The invention concerns a special dairy food composition consisting of processed mammal milk (that is having been subjected to a substantial modification of its original state) by acidification at pH less than 5.2 either by lactic acid fermentation or by direct input of lactic acid and antacid substances containing magnesium in the form of magnesium oxide or magnesium hydroxide or magnesium salts of weak organic or mineral acids or a mixture thereof, the final pH of the composition ranging between 4.5 and 7.5 and the total amount of magnesium contained in the composition ranging between 10 and 3000 milligrams per litre.

### FIELD OF THE INVENTION

The present invention relates to a method of preparation of special dairy food compositions—which can be used in animal or human food—containing on the one hand one or more milks of mammals (possibly added with milk proteins as well as various other additives), having been transformed—i.e. having undergone a substantial change from their state of origin—by acidification, either direct by contribution of lactic acid, or indirect by action of lactic bacteria or yeasts or moulds or various micro-organisms, said acidification conferring on these milks a pH lower than 5 suitable to the gelification of their caseins and containing, on the other hand acidity reducing substances containing magnesium in the form of oxide or of hydroxide or magnesium salts of weak organic or mineral acids, or of composed of magnesium and organic substances, or several of these substances having deacidizing properties, and this in quantities such as the pH of these special dairy food compositions, in their final state, is increased compared to that of processed milks, in their initial state, said increase in the pH conferring on these special dairy food compositions a greater sweetness and a lower aggressiveness with respect to the digestive mucous membranes; said magnesium contribution, on its side, allowing to carry out a better magneso-calcic balance, especially favorable to the nutrition and the health of adults.

The aims of this invention are thus of elaborating special dairy food compositions containing processed milks acidified then partly or entirely de-acidified, having a sweet taste and bringing to the consumers magnesium (in a organoleptically pleasurable form) of which many human beings, in the industrial societies, are deprived or sub-deficient.

This manufacturing process of special dairy food moderate acidity compositions, enriched in magnesium, is based on the fact that processed milks (standard yogurt) contain approximately 9 grams of lactic acid per liter and that even a small quantity of magnesium: 1.2 grams per liter is enough to neutralize this acid.

The special dairy food compositions described here can comprise various additives: various flavors, dyes, gelling, thickeners, stabilizers, amino acids, milk proteins, gelatin, taste enhancers, enzymes and possibly other complementary additions of lactic acid, in the course of manufacture process.

In the present request, the term “milk” applies to any milk of any terrestrial or marine mammal. The micro-organisms implied in the preliminary transformation of milks can be of any species provided that they neither are pathogenic, nor produce toxic substances or unpleasant tastes or odors.

In this request, the milks acidified by lactic fermentation or direct action of lactic acid are simply used as raw material at the time of the implementation of the manufacturing process of the special dairy food compositions by action of magnesic substances; the applicant is aware that the processes for obtaining fermented or acidified milks are not new, and therefore does not ask for their protection (the broadest references on fermented milks are in the following books: 1/Fermented milks 1989—John Libbey and company Ltd 13 Smith Yard—Summerley Street—London SW 18 4 HR England and 2/Food Microbiology Volume 2 food fermentations—1989 Technique and documentation Lavoisier, 11 Rue Lavoisier 75384 Paris cedex 08).

The present request relates only to the innovation and the inventive creation of the manufacturing process of the special dairy food compositions obtained using the mixture of milks processed beforehand by acidification and magnesium in the form of oxide, hydroxide or magnesium salts of weak organic or mineral acids or substances coming from the chemical reaction of magnesium with organic substances and complementarily of acid lactic.

### PREVIOUS TECHNIQUES

There are currently no examples in the literature or on the market of special dairy compositions which are manufactured from milks processed beforehand by yeast or chemical acidification to which one would add magnesium. The applicant underlines simply however that in France alone more than 500.000 tons of yogurt are consumed yearly (figure of 1985—source book : “Microbiologie Alimentaire” page 191) but however without magnesium addition.

Yogurt is the symbiotic fermentation of milk by the bacteria Streptococcus thermophilus and Lactobacillus delbruecki bulgaricus. In fermented milks, lactose is hydrolized in glucose and galactose. In yogurt, glucose is fermented in lactic acid. Yogurt contains approximately 9 grams of lactic acid per liter; the lactose content is lowered by approximately 19 grams compared to its content in unfermented milk (note: if milk is fermented by lactobacillus helveticus, its galactose content is also fermented).

Disadvantages of fermented milks.

1-acidity of yogurt

By taking the example of yogurt (the most consumed fermented milk), one notes that the acidity of yogurt, normal and without additives is approximately 3.9 to 4.4. People suffering from oesophagitis, backward gastro-oesophagial flow, gastritis or dyspepsia often poorly tolerate such acidity. The agro-alimentary industry, conscious of this problem, has turned the difficulty by selecting stocks of less acidifying bacteria. But if the pH is higher, above 4.7, casein gels less. The yogurt does not take. This problem is in its turn solved while adding thickeners to “soft yogurts”. More lactose remains however in these yogurts and there is less acid. Finally to hide acidity one adds a lot of sugar (for example some yogurts contain as much as 15 grams of sugar for 100 grams).

2 magnéso-calcic imbalance (in adults).

Milk is an excellent food for small mammals during growth as it brings, inter-alia, the nutriments necessary to the calcification of their skeletons. One liter of cow's milk contains 1.5 grams of calcium and 120 milligrams of magnesium. The Ca/Mg report/ratio is 12. Adults who doe not have to build their skeleton, doe not need much calcium (this is not entirely true for the old aged human who suffers from decalcification).

A study published in the English review Nature on Feb. 20, 1965 on page 741, Dr. Milton Winitz: “Evaluation of chemical diet as nutrition for man in space” showed that the daily needs for an adult are 720 milligrams of calcium and 240 milligrams of magnesium. The ratio of these needs is of 720/240=3. Thus a balanced food should present such a Ca:Mg ratio equal to 3.

The French population cruelly misses magnesium in its industrialized food manufactured with refined products. Very many people take drugs containing magnesium.

The Vidal Dictionnaire des Medicaments, in its 2001 edition enumerates at the heading “drugs containing magnesium” 136 proprietary medical products (Vidal dictionary: editor OVP 33 avenue of Wagram Paris cédex 17).

Thus, special dairy food compositions containing milks processed by lactic fermentation or lactic addition of acid containing a selected quantity of magnesium in such way that the average daily consumption of the composition provides to the organization between 50 and magnesium 600 milligrams would be useful for the health of the consumers while allowing them to eat sweet and non aggressive special compositions food dairy for fragile digestive mucous membranes (nature publishing group—the Mac Millian Building—4 Crinian Street—London N1 9XW).

### DISCLOSURE OF INVENTION

The preparation of the milks processed by lactic fermentation or by addition of lactic acid does not form part of the invention. These products are here basic substances used at the time of the manufacture of the special dairy compositions food exposed.

1/Preliminary Experimentation. To make sure that the addition of magnesium to acid processed milks would not give them a bad taste, the applicant carried out an evaluation of the action of magnesium on lactic acid—which leads to the formation of magnesium lactate—in wide solution. Indeed, in the book Merck Index 1976 note 5495 Page 737, it is said concerning the magnesium lactate “White crystal, very bitter powder”. (editor Merck and company, Rahway, N.J., the USA).

The applicant manufactured a solution-suspension of magnesium oxide and lactic acid by mixing 500 milligrams of magnesium oxide with 190 milliliters of water. He added to this preparation lactic acid in aqueous solution at 3%. The addition of 72 mls of this solution gave the suspension a pH higher than 7. A new addition of 8 mls of lactic aqueous solution lowered the pH to 6.1 (total lactic acid=2.4 grs). The pH still dropped until 5 with a complementary addition of 0.15 grs lactic acid. For a total quantity of 2.71 grs lactic acid the pH was 4.7; then 4.4 for 3.09 grs; finally 4.2 for 3.27 grs of acid. The magnesium lactate solution had only a very tiny bitterness for all pH values. The bitterness of magnesium lactate is only true for the powder form, not for a diluted solution (just as pure salt is aggressive and then diluted salt solutions are not). The applicant did check, by asking the assistance of “tasters” that magnesium in acidified milks does not give them any detectable bitterness. It was also shown by experimentation that the careful addition of antiacid magnesic substances in the special dairy food compositions does not deteriorate their texture or their structure.

2/Process of Manufacture.

This experimentation carried out, the applicant did check the action of magnesium (for example in the form of magnesium oxide) on milk acidified beforehand (for example by lactic fermentation in the case of yogurt). Yogurt contains on average 9 grams of lactic acid per liter: 1.2 grams of magnesium or 2 grams of magnesium oxide are enough to neutralize this acid. The applicant thus manufactured acidified milk whose pH was increased with magnesium oxide.

Manufacture. To one liter of yogurt of normal quality, of pH 4.1, is added magnesium oxide by successive amounts of 100 milligrams while the composition is mixed very slowly. Sub-total quantities of oxide of magnesium added, each followed, by the pH obtained: (100 mgs, pH=4.2)—(200 mgs, pH=4.3)—(300 mgs, pH=4.5)—(400 mgs, pH=4.6)—(600 mgs, pH=4.7)—(800 mgs,pH=4.9)—(1000 mgs, pH=5.3)—(1200 mgs,pH=5.7).

Texture, the consistency and organoleptic qualities of yogurt, even deacidized until a pH 5.7, were not modified. Many people who tasted the sweetness of the special dairy food composition, did not detect bitterness even with 1200 mgs of MgO per liter. Modulation of the magnesium content and pH of the special dairy food compositions.

A composition manufactured so that in 250 milliliters of yogurt there are 300 mgs of MgO (magnesium oxide) has thus 180 magnesium mgs, and its pH will be 5.7. The calcium content of this milk will be 1500 mgs per liter. The magnesium content will be 720 mgs per liter. The ratio Ca: Mg will be 2. If one manufactures another composition with 400 mgs of MgO for 500 yogurt mls, the composition will have pH 5. The quantity of Mg will be 480 mgs per liter. The Ca:Mg ratio will be 1500:480 is nearly 3. i.e. an ideal ratio.

The modulation of the addition of magnesium thus modifies the pH of the composition.

In fact, moreover, one can obtain special food compositions containing various percentages of magnesium for the same pH and this by the following process: having manufactured, for example, 1 liter of composition containing yogurt with 1200 magnesium oxide mgs per liter (corresponding to 720 magnesium mgs), this composition has a pH 5.7. If one adds to this composition 9 grams of lactic acid, a sufficient quantity to neutralize 1.2 magnesium oxide gr., one obtains a composition having a pH approximately 4.2. If, now one adds to this composition again 1.2 gr. of MgO, the pH will go up to 5.7 one obtains a composition containing then 2.400 milligrams of MgO per liter, i.e. 1.440 Magnesium mgs. Thus, by adding alternatively to the special dairy food compositions various quantities of magnesium and lactic acid, one will be able to confer on these compositions various magnesium contents for various pH. At the extreme, this process will make it possible to add magnesium to milk processed by acidification without modifying its pH.

On this subject, one should notice that there is neither known process to lower the acidity of milk transformed by magnesium addition, nor known process allowing to add magnesium to such milks without modifying their pH nor by modifying it in the modulated way which has been just described. It should be noticed, moreover, that the quantities of magnesium and lactic acid used to obtain these special dairy food compositions are not toxic and do not deteriorate their taste or their texture. The innovation, inventive creation and the harmlessness of the process described here are certain.

### MODES OF PREPARATION

### EXAMPLES

### Example 1 (Regarded as the Best)

The products implemented are
cow's milk, transformed beforehand into ordinary yogurt of fair commercial quality
food-quality magnesium oxide, in its “light” form

The yogurt is put to cool to 4 degrees centigrade during 4 hours. This temperature being reached, and the yogurt being well gelled, one adds to one liter of yogurt 1000 milligrams of magnesium oxide by small fractions and one carries out a very slow mixing of the special dairy food composition obtained, by adjusting the pH to 5.3 under control of an electronic pH-meter during the addition of MgO.

At the end of the preparation, the special dairy food composition contains approximately 75 mgs Magnesium for 125 milliliters. This quantity was selected so that the normal daily consumption of the special dairy food composition provides between 150 and 450 milligrams of magnesium to the body.

### Example 2 (Modulation)

In this example, one uses the same basic commodities. Milk being gelled by cooling to 4 degrees, one carries out the following additions
a/addition of about 1000 mgs magnesium oxide to one liter of yogurt and slow mixing until a pH 5.3 (under electronic control).
b/addition of about 4.5 grams lactic acid and slow mixing, until obtaining (under electronic control) pH 4.3.
c/addition of approximately magnesium oxide 1000 mgs until obtaining (under electronic control) a pH of 5.3.

The special dairy food composition contains approximately 150 milligrams of magnesium for 125 milliliters.

### Example 3 (Curdled Milk by Rennet then Acid: Modulation Magnesium and Lactic Acid)

Here the material used are
Curdled milk beforehand by acidification with lactic acid and rennet.
magnesium oxide as in the other examples.

One adds to the curdled milk 7 grs of lactic acid per liter and one brews at low speed. The pH is 4.4.

One adds then magnesium oxide by successive amounts of 200 milligrams. Thus various compositions are obtained:
magnesium oxide=200 mgs pH obtained: 4.7 Mg content=200 mgs/I
magnesium oxide=200 mgs pH obtained: 4.9 Mg content=400 mgs/l
magnesium oxide=200 mgs pH obtained: 5.3 Mg content=600 mgs/l
magnesium oxide=200 mgs pH obtained: 5.5 Mg content=800 mgs/I
magnesium oxide=200 mgs pH obtained: 5.8 Mg content=1000 mgs/l
magnesium oxide=200 mgs pH obtained: 6.1 Mg content=1200 mgs/I
magnesium oxide=200 mgs pH obtained: 6.4 Mg content=1400 mgs/l

This process makes it possible to manufacture special dairy food compositions in which casein was gelled by acidification and the rennet but whose pH is made higher by the presence of magnesium in quantities compatible with the daily nutritional contributions recommended for the human being.

### Conclusions

In conclusion, this process of deacidification modulated of the milks processed by fermentary or chemical acidification will make it possible to manufacture special dairy composition food of low aggressivity for the mucous membranes of the digestive tract and bringing a good magnesian food complement, as well as a good magneso-calcic balance favorable to the health of the consumers, in particular, adults.

1. Process allowing the reduction in acidity of special dairy compositions food made up of one or more milks of mammals, pure or mixed or skimmed entirely or partly or possibly added with various substances (such of dried milk, milk proteins, flavors, gelling and stabilizing agents, thickeners, the present list not being restrictive), having been transformed beforehand (i.e. having undergone a substantial change of their state of origin) by acidification, under the action either of one or more lactic fermentations, or of a direct contribution of lactic acid, this process of elevating the pH of the special dairy food composition being characterized by the fact that the reduction in acidity is obtained by the addition to these beforehand processed milks, after their temperature was lowered to 4 centigrade degrees, of substances containing magnesium in an antiacid form such as magnesium oxide, magnesium hydroxide or one of magnesium salts of the weak mineral or organic acids or a mixture of these various magnesian substances, this addition having the effect of decreasing the acidity of these compositions until pH in the range 4.3 to 7.5, this addition of magnesian substances being able to be split and intermixed in the course of manufacture with complementary additions with lactic acid, these additions, moreover, being followed by very slow mixing intended to preserve the gelled structure of the casein coagulated by the preliminary action of the acidification and the cold, this process being also characterized by the fact that the compositions obtained are magnesium enriched, and being characterized moreover by the fact that there is not rigorous match between pH and magnesium content of the compositions prepared, these pH possibly varying 0.2 more or less for one same magnesium content, depending on the milks used.

2. Process, according to the preceding claim, of reduction in acidity of a milk processed by lactic fermentation obtained with the bacteria Streptococcus thermophilus and lactobacillus delbruecki bulgaricus, (having a pH from approximately 3.9 to 4.5), i.e. a milk in the state of yogurt, characterized by the fact that one liter of yogurt is lowered to a temperature of 4 degrees and that one gram with magnesium oxide of light quality (container 600 milligrams of magnesium) is added to this yogurt, which is closely mixed with yogurt by a slow mixing, which confers on the special dairy food composition thus obtained a pH of 5.3 which pH can be obtained with a good precision when one adds 1 gram (or a little more or a little less) of oxide of magnesium to yogurt under control of an electronic pH-meter, this process being also characterized by the fact that it makes it possible to manufacture a special dairy food composition containing approximately 600 milligrams of magnesium per liter i.e. approximately 75 milligrams per 125 milliliters serving, this process being furthermore characterized by the fact that the match of the pH and the magnesium content indicated above is not rigorous but depends on the quality of the milks used, these pH possibly varying 0.2 more or less for one same magnesium content.

3. Process, according to the claim first, of reduction in the acidity of a milk processed by lactic fermentation fermentary obtained with the bacteria Streptococcus thermophilus and lactobacillus delbrueckiibulgaricus, (having a pH approximately 3.9 to 4.5), i.e. yogurt, characterized by the fact that one liter of yogurt is lowered to the temperature of 4 degrees and that to this yogurt are added magnesium oxide (preferentially of light quality) then lactic acid then again magnesium oxide, and this according to following process:
in a first stage one adds to yogurt 400 mgs magnesium oxide and one mixes by slow mixing by adjusting the pH with 4.6 by split additions of magnesium oxide under the control of an electronic pH-meter
in a second stage one adds 200 milligrams magnesium oxide while proceeding as at the time of stage 1 with adjustment of the pH to 4.7
in a stage 3, one adds 200 oxide mgs of magnesium and one proceeds as in stage 1 by adjusting the pH to 4.9;
in a stage 4, one adds 200 oxide mgs of magnesium and one proceeds as in 1 stage 1 by adjusting the pH to 5.3;
in a stage 5, one adds 400 oxide mgs of magnesium and one proceeds as in stage 1 by adjusting the pH to 5.8;
in a stage 6, one adds 400 oxide mgs of magnesium and one proceeds as in stage 1 by adjusting pH to 6.1;
in a stage 7, one adds 400 oxide mgs of magnesium and one proceeds as in stage 1 by adjusting the pH to 6.5;
in a step 8, one adds 0.9 gram of lactic acid by fractions and one mixes, the pH being adjusted to 6.1;
in a stage 9, one proceeds as in stage 8, the pH being adjusted to 5.8;
in a stage 10, one proceeds as in stage 8, the pH being adjusted to 5.3;
in a stage 11, one proceeds as in stage 8, the pH being adjusted to 4.8;
in a stage 12, one adds 400 magnesium oxide mgs in a split way, by adjusting pH to 5.0 under control of a pH measures;
in a stage 13, one adds 400 magnesium oxide mgs in a split way, while adjusting the pH with 5.3 under control of a pH-meter, these various stages leading to the production of specialized dairy food compositions having the following properties
1 pH=4.6—magnesium per liter=240 milligrams.
2 pH=4.7—magnesium per liter=360 milligrams.
3 pH=4.9—magnesium per liter=480 milligrams.
4 pH=5.3—magnesium per liter=600 milligrams.
5 pH=5.8—magnesium per liter=480 milligrams.
6 pH=6.1—magnesium per liter=600 milligrams.
7 pH=6.5—magnesium per liter=840 milligrams.
8 pH=6.1—magnesium per liter=1080 milligrams.
9 pH=5.8—magnesium per liter=1320 milligrams.
10 pH=5.3—magnesium per liter=1320 milligrams.
11 pH=4.8—magnesium per liter=1320 milligrams.
121 pH=5.0—magnesium per liter=15é0 milligrams.
13 pH=5.3—magnesium per liter=1800 milligrams.
said process being also characterized by the fact that it makes it possible to manufacture special dairy food compositions having for the same acidity of the different contents magnesium, the magnesium content possibly varying from 10 to 3000 milligrams per liter and the pH ranging from 4.1 to 7.5 according to the types of milks used and respective quantities of magnesium oxide and lactic acid implemented, this process being further characterized by the fact that the match of the pH and the magnesium content indicated above is not rigorous but depends on the quality of the milks implemented, these pH possibly varying 0.2 more or less for the same magnesium content.

4. Process, according to claim 1, of reduction in acidity, of milks processed beforehand by chemical acidification and lactic fermentation, characterized by the fact that to one liter of milk whose casein was beforehand gelled by action of rennet and calcium chloride and temperature of 30 degrees and presence of the bacteria Stretrococcus Thermophilus and lactobacillus delbruecki bulgaricus and whose pH is approximately 4.7, one adds, after cooling to 4 centigrade degrees:
in a first stage 2 grams of lactic acid which after careful mixture, intended to preserve the structure of the casein gel, confers on the mixture an approximate pH of 4.2
in a second stage one adds to the composition 200 milligrams of magnesium oxide which after homogeneous mixture confers has an approximate pH of 4.4,
in the following stages (stages 3 to 7) one adds each time 200 milligrams of magnesium oxide, the composition having the following successive pH:
with 400 mgs MgO per liter, the pH is 4.5;
with 600 mgs/l, it is 4.7;
with 800 mgs/l, it is 5;
with 1000 mgs/l, it is 5.3;
with 1200 mgs/l, it is 5.8;
these various pH being slightly variable according to the quality of milks which are used;
in a stage 8, one adds 2 grs of lactic acid has the composition which takes a pH of 5;
that in a stage 9, one adds 2 more grs of lactic acid, pH being 4.6;
that in a stage 10, one roughly adds 1 gram of lactic acid the pH rising to 4.5;
that in stages 11, 12 and 13, one add has each time 400 milligrams of magnesium oxide per liter what after mixture confers on the composition the following pH
stage 11, pH 5.
stage 12, pH 5.3,
stage 13. pH 5.8;
said process being characterized moreover by the fact that it makes it possible to prepare several special dairy food compositions containing milks processed by action of rennet and fermentation described above, having various pH and being able to contain for the same pH of the more or less large quantities of magnesium, ranging from 120 to 1.440 milligrams per liter for pH in the range of 4.2 A 5.9, said pH could possibly range from 5.8 to 7.5 if one brings complementary quantities of magnesium oxide in similar stages 14 to 19, the quantity of magnesium and lactic acid being able to be higher or lower, depending on the pH and the magnesium content of the composition that one wishes to obtain, this process being furthermore characterized by the fact that the match of the pH and the magnesium content indicated above is not rigorous but depends on the quality of the milks used, these pH possibly varying 0.2 more or less for the same magnesium content.

5. Process, according to claim 1, of reduction in acidity, in milks processed beforehand by chemical acidification by lactic acid characterized by the fact that one liter of milk whose casein was gelled in consequence of lowering its pH to 4.4 and roughly containing 7 grams of lactic acid per liter, one adds successively the following quantities of magnesium oxide which after careful mixture confers on the dairy food compositions obtained pH indicated below:
magnesium oxide=200 mgs pH obtained: 4.7—Mg content=200 mgs/l
magnesium oxide=200 mgs pH obtained: 4.9—Mg content=400 mgs/l
magnesium oxide=200 mgs pH obtained: 5.3—Mg content=é00 mgs/l
magnesium oxide=200 mgs pH obtained: 5.5—Mg content=800 mgs/l
magnesium oxide=200 mgs pH obtained:.5.8—Mg content=1000 mgs/l
magnesium oxide=200 mgs pH obtained: 6.1—Mg content=1200 mgs/l
magnesium oxide=200 mgs pH obtained: 6.4—Mg content=1400 mgs/l
said process making it possible to manufacture milks with casein gelled by acidification but whose pH is increased by the presence of magnesium, these milks having moreover high active magnesium content, compatible with the nutritional contributions recommended in the human being, this process being furthermore characterized by the fact that the match of the pH and the magnesium content indicated above is not rigorous but depends on the quality of the milks used, these pH possibly varying 0.2 more or less for the same magnesium content.

6. Process, according to claim 1, for lowering acidity, in milks processed beforehand by chemical acidification by lactic acid and the action of rennet, characterized by the fact that to one liter of milk whose casein was gelled by lowering its pH to 4.4 and roughly containing 7 grams of lactic acid per liter, one adds successively the following quantities of magnesium oxide what after careful mixture confers on the special dairy food compositions thus obtained the pH indicated below
magnesium oxide=200 mgs pH obtained: 4.7—Mg content=200 mgs/l
magnesium oxide=200 mgs pH obtained: 4.9—Mg content=400 mgs/l
magnesium oxide=200 mgs pH obtained: 5.3—Mg content=600 mgs/l
magnesium oxide=200 mgs pH obtained: 5.5—Mg content=800 mgs/l
magnesium oxide=200 mgs pH obtained: 5.8—Mg content=1000 mgs/l
magnesium oxide=200 mgs pH obtained: 6.1—Mg content=1200 mgs/l
magnesium oxide=200 mgs pH obtained: 6.4—Mg content=1400 mgs/l
said process making it possible to manufacture milks with casein gelled by acidification and the action of rennet (or chymosine) but whose pH is high by the presence of magnesium, these milks having moreover a high magnesium content, compatible with the daily nutritional contributions recommended in the human being, this process being furthermore characterized by the fact that the match of the pH and the magnesium content indicated above is not rigorous but depends on the quality of the milks used, these pH possibly varying 0.2 more or less for the same magnesium content.

7. Process, according to claim 1, of reduction in acidity, the milks processed beforehand by chemical acidification by lactic acid and the action of rennet, characterized by the fact that to one liter of milk whose casein was gelled by lowering of its pH to 4.4 and roughly containing 7 grams of lactic acid per liter, one adds 1000 milligrams of magnesium oxide which after careful mixture entrusts to this special dairy food composition thus obtained a pH of 5.8 and a magnesium content of 600 milligrams per liter compatible with the daily nutritional contributions recommended in the human being, by the fact that the match of the pH and magnesium content indicated above is not rigorous but depends on the quality of the milk used, these pH possibly varying 0.2 more or less for the same magnesium content.

8. Process, according to claim 1, of reduction in acidity, milks transformed beforehand by chemical acidification by lactic acid characterized by the fact that to one liter of milk whose casein was gelled in consequence of lowering its pH to 4.4 and roughly containing 7 grams of lactic acid per liter, one adds 800 milligrams of magnesium oxide which after careful mixture confers on the special composition food dairy obtained a pH of 5.5, this process making it possible to manufacture a curdled milk with casein gelled by the acidification but whose pH is elevated by the presence of magnesium, this milk having moreover a magnesium content compatible with the nutritional contributions recommended for human beings, this process being furthermore characterized by the fact that the match of the pH and the magnesium content indicated above is not rigorous but depends on the quality of the milk used, this pH possibly varying 0.2 more or less for the same magnesium content.

9. Process, according to claim 1, of reduction in acidity, in milks processed beforehand by chemical acidification and lactic fermentation, characterized by the fact that to one liter of milk whose casein was beforehand gelled by action of rennet and calcium chloride and temperature of 30 degrees and presence of the bacteria Stretrococcus Thermophilus and lactobacillus delbruecki bulgaricus and whose pH is approximately 4.7, one add, after cooling to 4 centigrade degrees:
in a first stage 2 grams of lactic acid which after careful mixture, intended to preserve the structure of the frozen casein, confers on the mixture an approximate pH of 4.2;
that in a second stage one adds to the composition 800 milligrams of magnesium oxide which after homogeneous mixture confers on that an approximate pH of 5.2,
that in the third stage one adds 2 grs of lactic acid to the composition which takes a pH of 4.7,
that in the fourth stage one adds 400 milligrams of magnesium oxide per liter which after mixture confers on the composition the pH of 5.8,
that in the fifth stage one adds to lactic composition 2 grs of acid 15 which takes the pH of 5.5,
this process being characterized by the fact that it makes it possible to manufacture according to wishes 4 compositions having the following pH and contents magnesium:
magnesium content of 480 mgs per liter and a pH either of 5.2 or of 20 4.7;
magnesic content of 720 milligrams per liter and a pH either of 5.8 or of 5.5;
said process being still characterized by the fact that the match of the pH and the magnesium content indicated above is not rigorous but depends on the quality of the milk used, this pH possibly varying 0.2 more or less for the same magnesium content.
